(19) United States
(12) Patent Application Publication
(10) Pub. No.: US 2006/0015501 A1
(43) Pub. Date: Jan. 19, 2006

(54) System, method and program product to determine a time interval at which to check conditions to permit access to a file

(75) Inventors: Mohammad Sanamrad, Lidingo (SE); Tijs Wilbrink, Leiden (NL)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 11/179,394

(22) Filed: Jul. 12, 2005

(30) Foreign Application Priority Data
Jul. 19, 2004 (GB) 04162616

(51) Int. Cl. G06F 17/30

(52) U.S. Cl. 707/9

(57) ABSTRACT

System, method and program for controlling access to a file within a computer. A predetermined value of an attribute of the computer is identified. A current value of the attribute is determined. Periodically, a determination is made if the predetermined value matches the current value. If so, access to the file is allowed. If not, access to the file is prevented. The period at which the determination is performed is based on a type of the attribute. The attribute of the computer can be a physical location of the computer, a type of network connection of the computer, or a type of application program resident in the computer.

### FIELD OF THE INVENTION

The present invention relates generally to computers, and more particularly to control of access to files on a computer.

### BACKGROUND

Security of computers and their files/data is very important. Existing security arrangements include physical keys and Smartcards, and authentication based on user ID and password.

U.S. 2003/0217151 A1 discloses a computer having a GPS. Data within or a network access by the computer is correlated with location-based access control information. Access to the data or network at a physical location is then limited according to the location-based access control information. A physical location of the computer attempting to access the data or network can be determined, and the limiting of access is based on the physical location of the computer. The process of determining a location of the computer and acting on the location can be repeated.

An object of the present invention is to improve the control of access to a computer or a file within the computer.

### SUMMARY OF THE INVENTION

The present invention resides in a system, method and program for controlling access to a file within a computer. A predetermined value of an attribute of the computer is identified. A current value of the attribute is determined. Periodically, a determination is made if the predetermined value matches the current value. If so, access to the file is allowed. If not, access to the file is prevented. The period at which the determination is performed is based on a type of the attribute.

According to features of the present invention, the attribute of the computer can be a physical location of the computer, a type of network connection of the computer, or a type of application program resident in the computer.

### BRIEF DESCRIPTION OF THE FIGURES

FIG. 1 is a schematic diagram of a data processing system in which the present invention may be implemented.

FIG. 2 is a flow chart showing operational steps involved in a frequency control process.

### DETAILED DESCRIPTION OF THE PREFERRED EMBODIMENTS

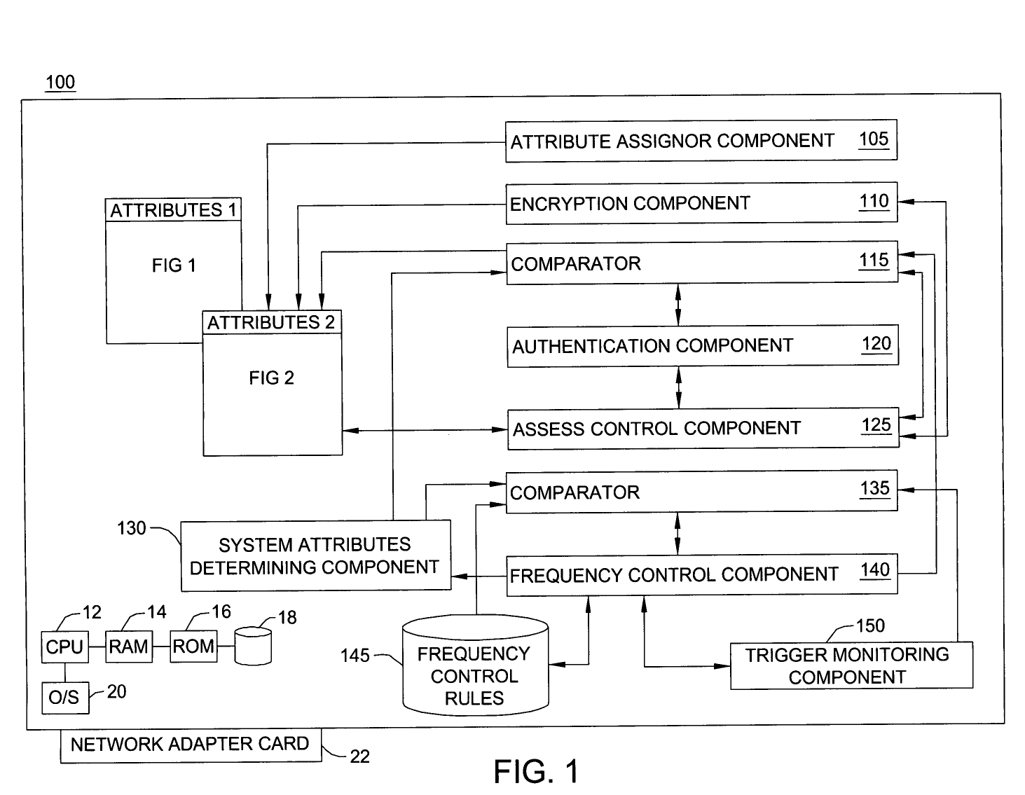

The present invention will now be described in detail with reference to the figures. FIG. 1 illustrates a computer 100 such as a mobile phone, a handheld computer, a personal digital assistant, a portable (laptop) computer, a desktop computer, a workstation or a mainframe computer in which the present invention may be implemented. Computer 100 includes standard CPU 12, RAM 14, ROM 16, disk storage 18, operating system 20 and network adapter card 22. Computer 100 locally stores File 1 such as a text document and File 2 such as an audio file. (File 1 and File 2 could also be other types of files such as video files, graphic files, web pages, etc.)

Each of File 1 and File 2 comprises an associated set of access control attributes, namely, Attributes 1 and Attributes 2, respectively. The access control attributes define conditions under which the respective computer is considered “secure”, and one or more files on the computer can be accessed. The access control attributes can represent a geographic position, or a type of application program resident on the computer such as a Web browser or an electronic calculator. The access control attribute can also represent a type of network connection such as a LAN (Local area Network) card or a WAN (Wide Area Network) card on the computer. The access control attribute can also represent a type of peripheral connection such as a connection to a CD drive, a connection to a printer etc. Because access control attributes are associated with a file itself, if the file is copied, transmitted etc., the access control attributes remain associated with that file. Also, by associating each set of access control attributes with a specific file, access can be permitted to one file but not another file, even though both files reside on the same computer.

An attribute assignor program function 105 is used to associate an access control attribute with a file. In one embodiment of the present invention, the attribute assignor program function 105 includes a menu, comprising access control attribute options selectable by a user, computer program, etc. In another embodiment, the user, computer program, etc. otherwise selects access control attributes. The access control attributes define conditions of a secure state where access is permitted, and conditions of an unsecure state where access is not permitted.

Optionally, the stored files can be encrypted (and decrypted) by an encryption program function 110. Encryption functions are widely understood by a person skilled in the art and will not be discussed further herein.

The computer 100 also comprises a system attributes determining program function 130 which determines the current system attributes of the computer. Function 130 will compare the current system attributes to respective, predefined access control attributes associated with the files. For example, if Attributes 1 represents a geographic position, the system attributes determining program function 130 determines the current geographic position of the computer using a GPS. If Attributes 1 represents a type of application program, the system attributes determining program function 130 determines the type of application program resident in the computer. If Attributes 1 represents a type of network connection, the system attributes determining program function 130 determines the type of network connection in the computer.

Multiple attributes can be associated with a single file, for example, a geographic position and a type of network connection. If multiple attributes are associated with a single file, the computer comprises multiple corresponding system attributes determining program functions. Furthermore, the access control attributes can be prioritized and only a subset need be enabled (e.g. only the access control attribute that defines a location is enabled). Moreover, if the geographic position determining program function is not available but the network connection determining program function is available, access control can be based only on the type of network connection.

Computer 100 also comprises a comparator 115 which compares the current system attributes (determined by the systems attributes determining program function 130) to the predefined access control attributes. Comparator 115 communicates with an authentication program function 120, which provides optional authentication of a request (e.g. from a user, a computer etc.) to access the file. In one example, the authentication program function 120 relies on a user ID and password. The comparator 115 also communicates with an access control program function 125 which permits or denies access to files, depending on the current conditions.

The computer 100 also comprises a comparator 135 and a frequency control program function 140 which access stored frequency control rules 145. (Even though comparator 135 and frequency control program function 140 are described herein reside on computer 100, the comparator 135 and the frequency control program function 140 can also be operable remotely to computer 100.) The frequency control rules 145 comprise a frequency control attribute that corresponds to a system attribute (and therefore, to an access control attribute) and a frequency value. The frequency control rules 145 control the frequency (or time interval or period) at which the systems attributes determining program function 130 determines the current system attributes, and the comparator 115 compares the current system attributes to the predefined access control attributes. For example, if Attributes 1 represents a geographic position, the system attribute is a geographic position and the frequency control attribute is a geographic position. In a frequency control rule described below, if the systems attributes determining program function 130 and the comparator 115 initially execute at intervals of ten minutes, the rule is used to control the frequency at which the systems attributes determining program function 130 and the comparator 115 execute. In the rule below, if the geographic position associated with the computer 100 (i.e. system attribute) corresponds to a geographic position associated with the user's office (i.e. frequency control attribute), then the frequency can be increased to intervals of two minutes. In the rule below, x,y (a geographic position) is the value of the frequency control attribute and two minutes is a frequency value:
Rule 1=if <system attribute>=x,y
   then
   frequency=2 minutes

In another example, if Attributes 1 represents a type of application program, the system attribute is also a type of application program and the frequency control attribute is a type of application program. In the frequency control rule below, if the systems attributes determining program function 130 and the comparator 115 initially execute at intervals of ten minutes, the rule invokes a change in frequency at which the systems attributes determining program function 130 and the comparator 115 execute. In the rule below, if the application program that is being executed by the computer 100 corresponds to a stand-alone electronic calculator application program, then the frequency is decreased to intervals of fifteen minutes. In the rule below, calculator.exe (an application program) is the value of the frequency control attribute and fifteen minutes is a frequency value:
Rule 2=if <system attribute>=calculator.exe
   then
   frequency=15 minutes

In yet another example, if Attributes 1 represents a type of network connection, the system attribute is also a type of network connection and the frequency control attribute is a type of network connection. In the frequency control rule below, if the systems attributes determining program function 130 and the comparator 115 are initially executing at intervals of ten minutes, the rule invokes a change in frequency at which the systems attributes determining program function 130 and the comparator 115 execute. In the rule below, if the type of network connection being utilised by the computer 100 corresponds to a LAN connection, then the frequency is increased to intervals of five minutes. In the rule below, 2.7.0.4 (a LAN connection) is the value of the frequency control attribute and five minutes is a frequency value:
Rule 3=if <system attribute>=2.7.0.4
   then
   frequency=5 minutes

Inputs to the comparator 135 comprise the system attributes (received from the systems attributes determining program function 130) and the frequency control attributes (accessed from the frequency control rules 145). The comparator 135 compares the system attributes against the frequency control attributes. The frequency control program function 140, responsive to this comparison, controls the frequency at which the systems attributes determining program function 130 and the comparator 115 execute.

In one embodiment, the comparator 135 compares the system attributes against the frequency control attributes continuously. In another embodiment, the comparator 135 compares the system attributes against the frequency control attributes in accordance with a trigger detected by a trigger monitoring program function 150.

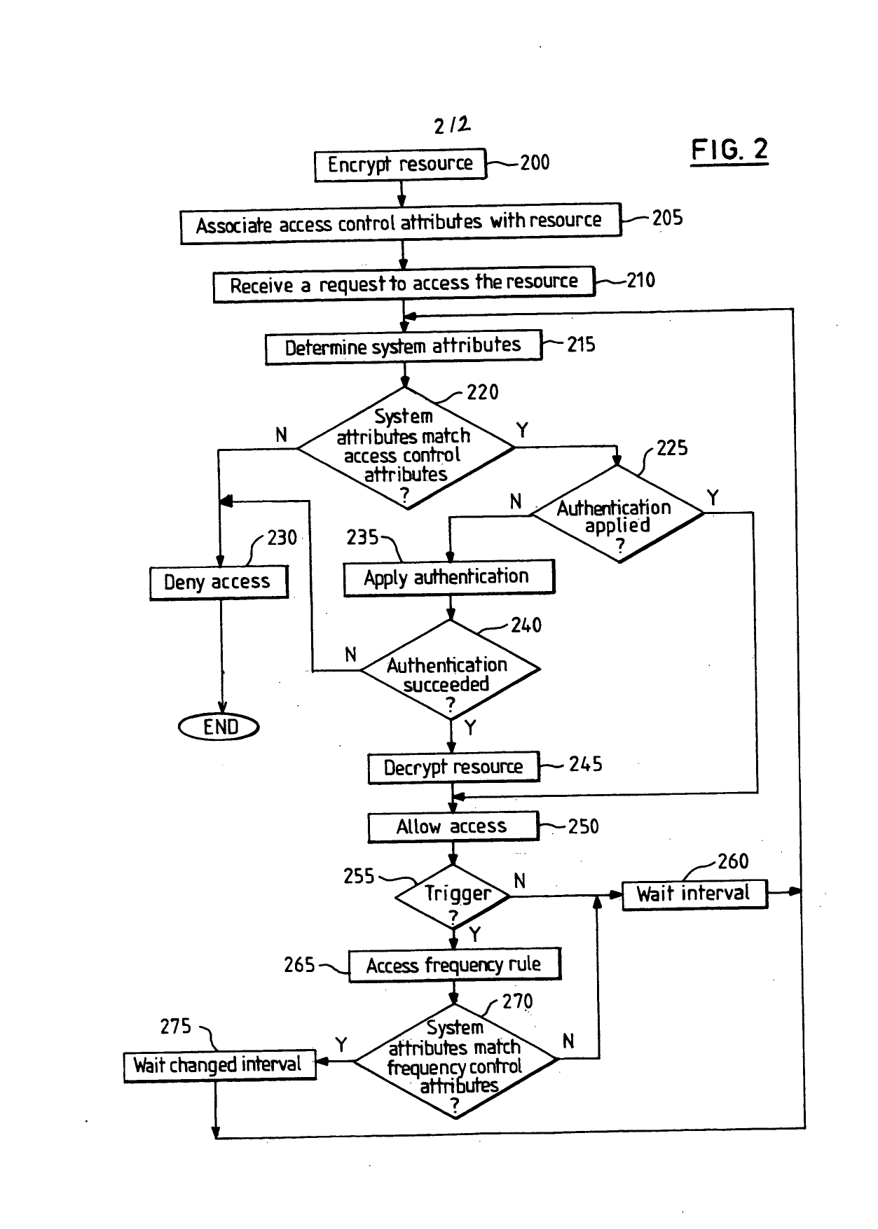

FIG. 2 illustrates programming within computer 100 according to a preferred embodiment of the present invention. At step 200, the encryption program function 110 encrypts File 1 and File 2. Next, a person or computer program uses the attribute assignor program function 105 to associate Attributes 1 and Attributes 2 with File 1 and File 2, respectively, (step 205). These attributes define conditions which allow access to the respective files. Alternately, these attributes define conditions which prohibit access to the respective files. In this example, Attributes 1 is a global position (i.e. x, y) associated with a user's office and Attributes 2 represents two types of connection: no network connection and a LAN connection. Next, at step 215, in response to a request (step 210) to access a file, the system attributes determining program function 130 determines current system attributes corresponding to Attributes 1 and Attributes 2. In this example, the system attribute representing global position is determined via a global positioning system and the system attribute representing the type of network connection is determined via a systems management application program. Next, the determined system attributes (in this example, “System attributes 1” is a global position of the user's office and “System attributes 2” is a WAN connection) are communicated to the comparator 115. The comparator 115 compares (step 220) the system attributes to the corresponding access control attributes, Attributes 1 and Attributes 2. System attributes, such as geographic location of the device, can change at any time. For example, the user may be carrying a portable computer and moving. As long as the system attributes are within the range of predefined access control attributes, access can be granted. In other words, as long as the system attributes are within the range of the predefined access control attributes, then decision 220 is “yes”. For example, as long as the computer is located in the user's employer's office building, access can be granted. However, when the user and his or her portable computer are located out of the office building, access will be denied or files are encrypted. If the system attributes do not match the access control attributes (negative result to step 220), the access control program function 125 is invoked, access to the file is denied (step 230) and the process ends. In this example, because System attributes 2 does not match Attributes 2, access to File 2 is denied. The term “matching” as used herein means exact matching, partial matching, within a predefined range, determination of equivalents or any other means of matching.

Referring back to step 220, if the system attributes match the access control attributes (positive result to step 220), a determination (step 225) is made as to whether the authentication program function 120 has been invoked in order to authenticate the request. In this example, because System attributes 1 matches or is in range of Attributes 1, the determination is made and because authentication has not yet been applied (negative result to step 225), the process passes to step 235 wherein the authentication program function 120 is invoked so that authentication can be applied. (On the next pass through the process, because authentication has already been applied, a positive result to step 225 is received and the process passes to step 250).

Next, the process passes to step 240 wherein a determination is made as to whether the request has been authenticated successfully. Referring to step 240, if the request is not authenticated (negative result to step 240), the access control program function 125 is invoked and access to the file is denied (step 230). If the request is authenticated (positive result to step 240), the encryption program function 110 is invoked to decrypt (step 245) the file. Next, the access control program function 125 is invoked and access to the file is allowed (step 250).

Next, the process passes to step 255, wherein the trigger monitoring program function 150 monitors for a trigger. In one example, the trigger is a time interval. In another example, the trigger is a user request. In another example, the trigger is a predetermined geographic location programmed into a GPS unit. If the trigger has not occurred (negative result to step 255) (e.g. a time interval has not passed or a request from a user is not received), the process passes to step 215 after a default time interval (step 260), which can be pre-set (in this example, the default time internal is ten minutes). Specifically, the frequency control program function 140 is notified that the trigger has not occurred and the frequency control program function 140 controls invocation of the system attributes determining program function 130 and the comparator 115, such that the process passes to step 215 after the default time interval.

If the trigger has occurred (e.g. a time interval has passed or a request from a user is received), (positive result to step 255), the comparator 135 is notified (e.g. via an alert), causing the comparator 135 to access (step 265) the frequency control rules 145. It should be understood that step 255 is optional and that in another embodiment of the present invention, the comparator 135 continuously accesses the frequency control rules 145, once access has been allowed in step 250.

With reference to step 265, in one example, Rule 1 above is accessed. In one embodiment, the comparator 135 uses a tag associated with a system attribute to search for an appropriate rule 145. For example, system Attribute 1 is: <position> x, y. In this example, the tag is “<position>” and the corresponding rule 145 shown below is also tagged (the rule tag is underlined below):
<position>=if <position>=x,y
   then
   frequency=2 minutes

At step 270, the comparator 135 compares the current system attributes (received from the system attributes determining program function 130) to the frequency control attributes specified in the rule. System attributes are checked regularly in decision 220 to ensure that they are still within the acceptable range. The interval for performing decision 220 has a predefined default value. For example, attributes can be checked every ten minutes. However, in certain conditions, for example if the user starts moving and the attribute is geographic location, the attributes may be checked more often. Decision 270 checks system attributes against attributes that are put into the rules to check if any rules should be applied to change the checking frequency, i.e., how often decision 220 should be performed. For example, when the user starts moving, the checking frequency increases and as the user gets closer to the office building borders, checking frequency increases more and more. In this example, system Attributes 1 (i.e. a position (x, y) associated with the user's office), matches the frequency control attribute specified in the rule (i.e. position “x,y”) (positive result to step 270). This causes the frequency control program function 140 to control an execution program function that executes the system attributes determining program function 130 and the comparator 115, such that the process passes to step 215 after a changed time interval (step 275) of two minutes. The frequency control program function 140 identifies the frequency value of two minutes from the frequency control rule.

If the process is repeated again (i.e. the process again passes to step 215), it should be understood that upon a negative result to step 255, the process passes to step 215 after the time interval (step 260) of two minutes. The process ends when a system attribute does not match an access control attribute (negative result to step 220), in which case, step 230 is executed. In an application of this rule, if a user is often mobile (e.g. travelling on public transport etc.), utilising the comparator 135 and the frequency control program function 140 allow for more stringent and automatic security checks that account for this mobility, by changing the frequency at which the system attributes determining program function 130 and comparator 115 execute.

In another example, rule 3 above is accessed. At step 270, the comparator 135 compares the system attributes (received from the system attributes determining program function 130) against the frequency control attributes specified in the rule. In this example, system Attributes 2 is a LAN connection (i.e. 2.7.0.4) and thus matches the frequency control attribute specified in the rule (i.e. LAN connection “2.7.0.4”) (positive result to step 270), causing the frequency control program function 140 to control the execution program function that executes the system attributes determining program function 130 and the comparator 115, such that the process passes to step 215 after a changed time interval (step 275) of five minutes (wherein the frequency value of five minutes is accessed by the frequency control program function 140 from the frequency control rule). In an application of this rule, because the detection of a LAN connection indicates a computer with a more unsecure state than a computer with no connection whatsoever and there is a probability that a WAN connection may be opened up at any time, the comparator 135 and the frequency control program function 140 are utilized to provide for more stringent security checks (i.e. by a frequency change) when a computer with a more unsecure state (but a computer wherein access is allowed) is detected.

It should be understood that the determination of a match by a comparator of current and predefined attributes can be implemented in many ways. In an example, the attributes are equivalents in value or substance, although the syntax of the attributes differ (e.g. the syntax of a position (x, y) is different to the syntax of another position (y, x), but both attributes correspond to the same global position). In this example, the determination of a match process involves a mapping step to map the two attributes, and then the comparator carries out partial matching. In this example, if one attribute has a value x, y, z, and the other attribute has a value x, y, then determination of a match only occurs based on the two values (i.e. x and y).

It should be understood, that the denial of access to a file can be implemented in many ways. In one example, an alert is invoked. In another example, the file is deleted. In yet another example, copying of the file is prevented. In yet another example, the computer 100 is locked. It should be understood, that the allowance of access to a file can be implemented in many ways. In one example, access to the file is allowed to a certain degree (e.g. read only access, write only access etc.).

The authentication mechanism is optional, however it provides extra security. It should also be understood that the authentication steps 225, 235, 240 can be applied directly after receiving a request (i.e. directly after step 210). In step 265, if a frequency rule cannot be accessed (for example, if a frequency rule for the current system attribute is not present), the process passes to step 260 (because a change in frequency is not invoked).

The program functions within computer 100 can be loaded from a computer storage medium such as a magnetic disk or tape, optical disk, DVD, etc. or downloaded from a network via network adapter card 22.

1. A method for controlling access to a file within a computer, said method comprising the steps of:
identifying a predetermined value of an attribute of said computer, determining a current value of said attribute, and periodically determining if said predetermined value matches said current value, and if so, allowing access to said file, and if not, preventing access to said file; and
determining the period at which said determining step is performed based on a type of said attribute.

2. A method as set forth in claim 1 wherein said attribute of said computer is a physical location of said computer.

3. A method as set forth in claim 1 wherein said attribute of said computer is a type of network connection of said computer.

4. A method as set forth in claim 1 wherein said attribute of said computer is a type of application program resident in said computer.

5. A method as set forth in claim 1 wherein the step of preventing access to said file comprises the step of encrypting said file.

6. A system for controlling access to a file within a computer, said system comprising:
means for identifying a predetermined value of an attribute of said computer, determining a current value of said attribute, and periodically determining if said predetermined value matches said current value, and if so, allowing access to said file, and if not, preventing access to said file; and
means for determining the period at which said determining step is performed based on a type of said attribute.

7. A system as set forth in claim 6 wherein said attribute of said computer is a physical location of said computer.

8. A system as set forth in claim 6 wherein said attribute of said computer is a type of network connection of said computer.

9. A system as set forth in claim 6 wherein said attribute of said computer is a type of application program resident in said computer.

10. A system as set forth in claim 6 wherein said means for preventing access to said file comprises means for encrypting said file.

11. A computer program product for controlling access to a file within a computer, said computer program product comprising:
a computer readable medium;
first program instructions to identify a predetermined value of an attribute of said computer, determine a current value of said attribute, and periodically determine if said predetermined value matches said current value, and if so, allow access to said file, and if not, prevent access to said file; and
second program instructions to determine, based on a type of said attribute, the period at which said first program instructions determine the current value of said attribute; and wherein
said first and second program instructions are stored on said medium.

12. A computer program product as set forth in claim 11 wherein said attribute of said computer is a physical location of said computer.

13. A computer program product as set forth in claim 11 wherein said attribute of said computer is a type of network connection of said computer.

14. A computer program product as set forth in claim 11 wherein said attribute of said computer is a type of application program resident in said computer.

15. A computer program product as set forth in claim 11 wherein said first program instructions prevent access to said file by encrypting said file.
